(19) United States
(12) Patent Application Publication
(10) Pub. No.: US 2005/0044894 A1
(43) Pub. Date: Mar. 3, 2005

(54) Deposition of silica coatings on a substrate

(76) Inventors: Douglas Nelson, Curtis, OH (US); Thomas Kemmerley, Monclova, OH (US); Michael P. Remington JR., Toledo, OH (US)

Correspondence Address: MARSHALL & MELHORN, LLC;4 Seagate, 8th Floor, Toledo, OH, 43604, US

(21) Appl. No.: 10/652,248

(22) Filed: Aug. 29, 2003

(51) Int. Cl. C03C 17/245

(52) U.S. Cl. 65/60.52; 65/60.8; 65/60.5

(57) ABSTRACT

A process for the production of a silica coating on a glass substrate provides a precursor mixture of SiH₄, NH₃, and O₂, preferably in the presence of C₂H₄ and an inert carrier gas. The precursor mixture is directed along a surface of the glass substrate in an atmospheric pressure, on-line, chemical vapor deposition process. The precursor mixture is reacted at the surface of the glass substrate to form a silica coating, essentially devoid of nitrogen, on the glass substrate.

### BACKGROUND OF THE INVENTION

1. Field of the Invention

The present invention relates to a continuous, chemical vapor deposition (CVD) method for producing a coated glass article, particularly, coated architectural glass or automotive glass, and to the coated article so produced. Specifically, the invention relates to an improved method for producing a glass article coated with a layer of silica (SiO₂), and the coated glass article formed thereby.

2. Summary of Related Art

U.S. Pat. No. 4,019,887 to Kirkbride et al. discloses the coating of glass with a layer of silicon or a silica complex by continuous chemical treatment of a hot glass substrate with a non-oxidizing gas containing a monosilane. Inclusion of ethylene in the non-oxidizing gas of the Kirkbride et al. process to improve resistance of the silica complex layer to attack by alkali compounds is described in U.S. Pat. No. 4,188,444 to Landau.

A method of pyrolytically forming a silica-containing coating on a glass substrate at an elevated temperature is found in U.S. Pat. No. 5,798,142. U.S. Pat. No. 5,798,142 is hereby incorporated by reference as if set forth in its entirety herein. In this patent, silane, oxygen, a radical scavenger gas and a carrier gas are combined as a precursor mixture, and the precursor is directed toward and along the surface of the heated glass substrate. The presence of the radical scavenger allows the silane, which is pyrophoric, to be premixed with the oxygen without undergoing ignition and premature reaction at the operating temperatures. The radical scavenger further provides control of and permits optimization of the kinetics of the chemical vapor deposition (CVD) reaction on the glass. A preferred combination of precursor materials includes monosilane and oxygen, with ethylene as the radical scavenger, and includes nitrogen or helium as a carrier gas.

U.S. Pat. No. 5,939,210 discloses a method of forming reflective layers on glass. This reference discusses the use of silane in addition to ammonia or an amine to form a silicon/nitrogen coating on a glass sheet. U.S. Pat. No. 5,939,210 does not disclose the use of oxygen in the reaction.

U.S. Pat. No. 6,444,588 discloses the use of an oxygen containing precursor, a silicon containing precursor and a nitrogen containing precursor in the formation of an anti-reflective coating on a glass substrate used in a printed circuit. The reactants are combined in a plasma electric CVD process to form an anti-reflective coating.

Known processes for the production of silica layers on a substrate through CVD processes are limited in the thickness or efficiency of the deposition process, and also by powder formation (pre-reaction) of the reactive elements. Therefore, it is desired to devise an improved process for the formation of silica layers on a substrate.

### SUMMARY OF THE INVENTION

In accordance with the present invention, there is provided an improved method for the deposition of a silica layer on a substrate. A silica layer, as defined herein, is a coating containing primarily silicon dioxide, and possibly containing trace contaminants, for example carbon. Specifically, the invention relates to the atmospheric pressure chemical vapor deposition of a silica layer from a combination of either: a silane, ammonia and oxygen (SiH₄/NH₃/O₂); or a silane, ammonia, ethylene (ethene) and oxygen (SiH₄/NH₃/C₂H₄/O₂), on a glass substrate. Preferable, the silane used is monosilane (SiH₄). It has been found, in conjunction with the method of the present invention, that the presence of the ammonia allows the silane, which is pyrophoric, to be premixed with the oxygen without undergoing ignition and premature reaction at the operating temperatures. Also, minimal nitrogen, preferably less than about 1 atomic percent, can be incorporated into the coating, thereby leaving a substantially “pure” silica coating on the substrate. The silica coating can be used alone or in combination with additional coatings applied to the substrate.

In the method of the present invention, precursor materials including ammonia, a silane, an oxygen containing material, optionally a carrier gas or gases and optionally a radical scavenger, are combined within a distributor beam device or the like, and the mixture is directed toward and along the surface of the glass substrate passing therebeneath. The most preferred combination of precursor materials includes ammonia (NH₃), monosilane (SiH₄), oxygen gas, ethylene (C₂H₄) as the optional radical scavenger and helium and/or nitrogen as the inert carrier gas.

### DETAILED DESCRIPTION OF THE PREFERRED EMBODIMENT

The method of the present invention is preferably carried out in an on-line, float glass production process, which is well known in the art. An example of such a process can be found in U.S. Pat. No. 5,798,142 which was described hereinabove, and which has been incorporated by reference herein.

In a preferred embodiment of the present invention, a heated glass substrate is provided, the substrate having a surface on which the coating is to be deposited. A silane, oxygen, ammonia, preferably an inert carrier gas and preferably, a radical scavenger gas, are combined to form a precursor mixture, which is directed toward and along the surface to be coated, preferably in a laminar flow. The mixture is reacted at or near the surface of the glass substrate to form the silica coating. Subsequently, the coated glass substrate is cooled to ambient temperature. Preferably, the inert carrier gas is either helium or nitrogen or a combination thereof. While other silanes may be used in embodiments of the present invention, it has been found that monosilane is the preferred silane for use in the present invention. Oxygen gas is the preferred oxygen source for use in the present invention, but it is possible, within the scope of the present invention, that other oxygen sources may also be used.

In general, the deposition by CVD of a precursor containing only silane produces a coating of amorphous silicon on a substrate. When oxygen alone is added to the silane precursor, silica is produced, but it is produced at unacceptably high rates, resulting in an explosive reaction. Known methods of preventing such an explosive reaction result in deposition of coatings at very low, commercially impractical rates, typically resulting in unacceptably thin layers. Known methods are also limited in the amount silane and oxygen can be increased in the reactants, as too much concentration results in gas phase reaction of the elements, and no film being produced. It is known that the addition of ethylene to the reaction of silane and oxygen reaction provides silica coatings at an acceptable rate.

Typically, the combination of ammonia and silane, with other components, in a precursor mixture has been used to produce Si₃N₄ coatings. Experimental results indicate that in the inventive atmospheric pressure CVD process, the combination of silane and ammonia alone yields no coating, no Si₃N₄, and no amorphous silicon at temperatures <about 1290 degrees F. Typically, at relatively high temperatures (>about 1290 degrees F.), the addition of an oxidant to the precursor mixture has been found to result in the formation of a coating comprising some combination of Si/O/N, which is a typically a relatively high refractive index material (>about 1.6) that varies with the amount of oxygen and nitrogen incorporated. The refractive index of the coated sheet varies based upon the relative concentration of silica/silica nitride in the coating.

In the process of the present invention, however, it has surprisingly and unexpectedly been found that the addition of ammonia to a known CVD process for the deposition of silica results in a silica coating with trace (less than about 1 atomic percent) to undetectable amounts of nitrogen in the silica coating. Thus, in the process of the present invention, the process for the production of a silica coating can be improved through the addition of ammonia to the precursor combination, without adding detectable levels of nitrogen to the silica coating. Afforded benefits include increased deposition efficiency and advantageous changes to the reaction profile. The coating produced by the present invention typically has a refractive index in the range of about 1.45-about 1.55, which is indicative of a silica layer essentially lacking any nitrogen component.

In a preferred embodiment of the present invention, the precursor mixture comprises about 0.1-about 3.0 percent silane, about 1.5-about 9 percent oxygen, about 1.5-about 9 percent ethylene and about 7.5-about 60 percent nitrogen, with the remainder comprising inert carrier gas. The above concentrations are expressed in gas phase percentages.

Even more preferably, the precursor mixture of the present invention comprises: about 1.5 percent silane, about 6 percent oxygen, about 4.5 percent ethylene and about 15 percent nitrogen, with the remainder comprising inert carrier gas.

### EXAMPLES

The following examples reflect actual experimental results carried out in an experimental laboratory setting. Experiments were designed using Harold Haller's EDO software. Some examples of the conditions provided by the design are given in the following tables. All depositions were carried out using a total flow of 30 slm and a SiH₄ concentration of 1.5% using a laboratory conveyor furnace at 1170 degrees F. Table 1 demonstrates the results of the SiO₂ coatings in the absence of ethylene or any other radical scavenger. Coating thickness was determined optically and is reported in Angstroms. Essentially any remaining component in the examples comprises inert carrier gas. Good repeatability is highlighted by examples 1 and 3.

TABLE 1

| Example | % O2 | % C2H4 | % NH3 | Thickness |
|---|---|---|---|---|
| 1 | 9 | 0 | 60 | 385 |
| 2 | 3 | 0 | 15 | 170 |
| 3 | 9 | 0 | 60 | 360 |
| 4 | 3 | 0 | 60 | 350 |
| 5 | 6 | 0 | 60 | 370 |
| 6 | 9 | 0 | 15 | 310 |

Table 2 shows the results of comparative examples suggested by the different experimental designs in the absence of NH₃. These examples basically illustrate current SiO₂ deposition technology as illustrated by U.S. Pat. No. 5,798,142. Examples 7, 8 and 15 highlight the repeatability of these known processes.

TABLE 2

| Example | % O₂ | % C₂H₄ | % NH₃ | Thickness |
|---|---|---|---|---|
| 7 | 6 | 9 | 0 | 360 |
| 8 | 6 | 9 | 0 | 340 |
| 9 | 9 | 9 | 0 | 360 |
| 10 | 3 | 9 | 0 | 310 |
| 11 | 9 | 1.5 | 0 | 180 |
| 12 | 3 | 1.5 | 0 | 280 |
| 13 | 3 | 9 | 0 | 310 |
| 14 | 6 | 1.5 | 0 | 260 |
| 15 | 6 | 9 | 0 | 360 |

As illustrated in Table 1, essentially pure SiO₂ coatings can be generated using just the combination of SiH₄, NH₃ and O₂. However, as shown in Table 3, the most positive results, in terms of deposition efficiency and altering the reaction profile, have occurred when using the combination of NH₃ and C₂H₄. It has been demonstrated in examples 16-33 that NH₃ addition to existing SiO₂ deposition technology, as illustrated by U.S. Pat. No. 5,798,142, affects the reaction profile forcing the reaction to take place over the entire coater face rather than directly under the nozzle. This may lead to a large decrease in pre-reaction, powder formation and increased manufacturing times/efficiencies.

TABLE 3

| Example | % O₂ | % C₂H₄ | % NH₃ | Thickness |
|---|---|---|---|---|
| 16 | 6 | 4.5 | 7.5 | 360 |
| 17 | 9 | 9 | 7.5 | 400 |
| 18 | 9 | 9 | 7.5 | 380 |
| 19 | 9 | 9 | 7.5 | 380 |
| 20 | 9 | 1.5 | 30 | 420 |
| 21 | 9 | 1.5 | 30 | 400 |
| 22 | 6 | 1.5 | 30 | 340 |
| 23 | 9 | 1.5 | 30 | 390 |
| 24 | 3 | 4.5 | 30 | 340 |
| 25 | 1.5 | 6 | 30 | 330 |
| 26 | 6 | 9 | 30 | 320 |
| 27 | 1.5 | 3 | 60 | 350 |
| 28 | 9 | 4.5 | 60 | 330 |
| 29 | 3 | 4.5 | 60 | 260 |
| 30 | 3 | 4.5 | 60 | 310 |
| 31 | 3 | 9 | 60 | 320 |
| 32 | 9 | 9 | 60 | 240 |
| 33 | 9 | 9 | 60 | 210 |

The increase in thickness/efficiency with this invention appears to be in the range of about 5-7% on average and as high as about 16% when compared to similar deposition conditions not utilizing NH₃. The present invention, however yields essentially pure SiO₂ coatings from a combination of SiH₄/NH₃ and an oxidant, without ignition of the pyrophoric silane. The nitrogen content of the coatings are preferably less than about 1 atomic percent, or in other words less than the detection limit of standard instrumentation (Auger electron spectroscopy and X-ray electron spectroscopy) used for testing the nitrogen concentration in the coating. Additionally, the change in reaction profile when NH₃ is added to existing SiO₂ deposition chemistry could mean less pre-reaction, as stated above.

All of the above results were then analyzed using multiple correlation analysis (MCA) techniques, using Harold Haller's MCA software for this purpose. The graph below pictorially represents the model that was generated using MCA.

[image]

The model suggests that the growth of SiO₂ in this system is independent of O₂ concentration in the design range (about 1.5 to about 9%), but dependent on both NH₃ and ethylene concentrations.

With regard to the experimental model utilized above: 1) The thickness increases with an increase in NH₃ concentration to a maximum then decreases. 2) The peak thickness is achieved with a lower % of NH₃ as the % ethylene increases. 3) The biggest boost to coating thickness is when NH₃ is added to a gas stream containing a relatively low % of ethylene.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A process for depositing a silica coating upon a heated glass substrate comprising the steps of:
a) providing a heated glass substrate having a surface upon which the coating is to be deposited; and
b) directing a precursor mixture comprising a silane, ammonia, oxygen and an inert carrier gas toward and along the surface to be coated, and reacting the mixture at or near the surface to form a silica coating on the surface of the glass substrate.

2. The process for depositing a silica coating upon a glass substrate as claimed in claim 1, comprising providing a radical scavenger and adding the radical scavenger to the precursor mixture.

3. The process for depositing a silica coating upon a glass substrate as claimed in claim 1, wherein the silane is monosilane.

4. The process for depositing a silica coating as claimed in claim 2, wherein the radical scavenger gas in the precursor mixture is selected from the group consisting of ethylene and propylene.

5. The process for depositing a silica coating as claimed in claim 4, wherein the radical scavenger gas is ethylene.

6. The process for depositing a silica coating as claimed in claim 1, wherein the resultant coating on the glass substrate comprises less than about 1 atomic percent nitrogen.

7. The process for depositing a silica coating as claimed in claim 1, comprising providing an inert carrier gas and adding the inert carrier gas to the precursor mixture, prior to directing the precursor mixture toward and along the surface to be coated.

8. The process for depositing a silica coating as claimed in claim 7, wherein the inert carrier gas comprises at least one of nitrogen and helium.

9. The process for depositing a silica coating as claimed in claim 1, wherein the precursor mixture comprises about 0.1-about 3.0 percent silane, about 1.5-about 9 percent oxygen, about 1.5-about 9 percent ethylene and about 7.5-about 60 percent ammonia, with the remainder comprising an inert carrier gas.

10. A coated glass article formed according to the process of claim 1.

11. The coated glass article according to claim 10, wherein the nitrogen concentration in the silica coating is less than about 1 atomic percent.

12. The coated glass article according to claim 10, wherein the refractive index of the coating is between about 1.45 and about 1.55.

13. The process for depositing a silica coating as claimed in claim 9, wherein the precursor mixture comprises about 1.5 percent silane, about 6 percent oxygen, about 4.5 percent ethylene and about 15 percent ammonia, with the remainder comprising an inert carrier gas.

14. The process for depositing a silica coating according to claim 1, wherein step b) comprises premixing the silane, ammonia, oxygen and the carrier gas to form the precursor mixture.

15. The process for depositing a silica coating according to claim 1, comprising cooling the coated glass substrate to ambient temperature.

16. A process for depositing a silica coating upon a heated glass substrate comprising the steps of:
a) providing a heated glass substrate having a surface upon which the coating is to be deposited; and
b) premixing monosilane, ammonia, oxygen and an inert carrier gas to form a precursor mixture, directing the precursor mixture toward and along the surface to be coated, and reacting the mixture at or near the surface to form a silica coating on the surface of the glass substrate.
